(19) United States
(12) Patent Application Publication
(10) Pub. No.: US 2003/0055756 A1
(43) Pub. Date: Mar. 20, 2003

(54) Method of making money payments

(76) Inventor: Frederick Aley Allan, Baltimore, MD (US)

Correspondence Address: Frederick Aley Allan, 825 Lenton Avenue, Baltimore, MD, 21212, US

(21) Appl. No.: 10/241,045

(22) Filed: Sep. 11, 2002

Related U.S. Application Data
(60) Provisional application No. 60/322,592, filed on Sep. 17, 2001.
(60) Provisional application No. 60/347,025, filed on Jan. 10, 2002.
(60) Provisional application No. 60/391,876, filed on Jun. 26, 2002.

(51) Int. Cl. G06F 17/60

(52) U.S. Cl. 705/33

(57) ABSTRACT

The system disclosed is for making payments using a new type of bank check combined with electronic funds transfer (EFT) facilities The new type check is not a negotiable instrument and is intended for delivery to the payor's bank rather than to the payee. The check instructs the payor's bank to make a payment by EFT from the payor's bank account directly to the bank account of the payee at the payee's bank, normally via the Federal Reserve's Automated Clearing House (ACH) facility. The system includes means for making a true, but inoperative, copy of each check at the time the check is written. Other embodiments of the invention are special checks, which look like conventional checks, but on their reverse sides display printed matter stating that they are non-negotiable and are payable only pursuant to special procedures.

### FIELD

This invention relates to money and banking, specifically to the use of a new type of check combined with electronic transfer of funds to facilitate money payments.

This application is entitled to the benefits of the following Provisional Patent Applications: Application No. 60/322,592, filing date Sep. 17, 2001; Application No. 60/347,025, filing date Jan. 10, 2002 and Application No. 60/391,876, filing date Jun. 26, 2002.

### SUMMARY

The invention disclosed herein is for a system of making non-cash payments by using a novel type of check in combination with existing well-known means for electronic transfers of funds between banks, notably the Automated Clearing House facility of the Federal Reserve System. Other versions of the invention rely on specially indorsed conventional checks to initiate electronic funds transfers.

### BACKGROUND

For many years paper checks, signed manually by a payor and delivered to a payee in person or through the postal service, have been the normal means for paying bills or sending funds voluntarily to other parties. Millions of these paper instruments are executed every day in the United States and millions more in other countries. The expense associated with the traffic in such instruments is enormous.

Today's checks, referred to as “conventional checks” hereafter, are intended to be delivered by mail or other means directly to the named payees, then delivered by the payees by mail or other means to payee banks, then sent by payee banks to clearinghouses; thence, after settlement of net debt and credits of the banks in the clearing houses' regions, they are sorted and assembled for transport in bulk to the respective payor banks for cancellation and storage. This elaborate journey of paper checks through the payment system will be referred to frequently hereafter as the “paper route.”

The risks and costs of the paper route constitute a huge burden on the banking system and on society. Various means have been devised for reducing this burden, of which the most effective is usually referred to as “electronification.” Under this awkward rubric is a marvel of modern technology enabling the electronic transfer of funds, usually referred to as “EFT.” While ‘wire’ transfer of funds under the Federal Reserve's FedWire system has been operated electronically for some time, it is cumbersome and costly. A stream-lined version of EFT was created by the Federal Reserve in the early 1970s by the introduction of its Automated Clearing House (ACH) facility.

Electronification has been a great success and use of the ACH facility has been adopted by almost all sizeable business and professional organizations. Instructions for payments through the ACH facility are given by a variety of means such as credit and debit cards, ATM machines and other essentially electronic communications. The efficiency of this electronic system, however, has not greatly reduced the public's attachment to paper checks. These continue to be the principal means of non-cash payments in use today, especially by consumers, amounting to nearly 60% of all non-cash retail payments. The overall cost of the continued use of paper for making payments is a heavy burden on the banking system. The National Automated Clearing House Association (NACHA), which regulates the ACH Network, has adopted special measures to mitigate the costs of the paper route. Regrettably, these expedients have only made a small dent in the overall costs, and the use of paper checks continues to dominate the retail payment system of the United States.

According to Alice Rivlin, then Vice Chair of the Federal Reserve Board: “Americans love checks . . . . We wrote 64 billion of them in 1996 with a total value of about $75 trillion dollars. Pundits have been predicting the replacement of checks by electronic payments for several decades, and, indeed, electronic transactions have been increasing much faster in recent years than checks. Nevertheless, the volume of checks has continued to increase about 2 percent annually over the last five years. Growing use of credit and debit cards has slowed the increase in check volume, but so far has not reversed it. On-line home banking still accounts for a tiny fraction of payments. Moreover, the customer's bill paying instruction from a home computer often simply results in the bank cutting a check to pay the customer's bill, because many payees are not equipped to receive funds electronically. Hence, while the volume of checks is likely to plateau and eventually decline as electronic payments become increasingly convenient and familiar, checks are likely to remain a significant part of the payments system for some years to come.” Testimony of Vice Chair Alice M. Rivlin. “Role of the Federal Reserve in the Payment System” before the Subcommittee on Domestic and International Monetary Policy of the Committee on Banking and Financial Services, U.S. House of Representatives Sep. 16, 1997

Similar estimates of check numbers have been commonplace for many years. In 2001, however, the Federal Reserve made a new and comprehensive study, which concluded that only about 42.5 billion checks were written in the year 2000 with a total value of 39.3 trillion dollars. While this is much less than has been bruited about for many years by ostensibly authoritative sources, including the Federal Reserve itself, the numbers are still enormous.

The Federal Reserve has separately estimated the costs of mailing, handling and processing paper checks at around $3.00 per check. Taking these figures together indicates a total of over $125 billion to cover the costs of mailing, handling, storing and processing paper checks during the year 2000. Even though the study opined that the number of checks is now declining, it is clear that the costs associated with the use of paper checks continues to weigh heavily on the banking system.

The recent Federal Reserve study concluded with these words: “Although the number and value of checks may have begun to decline, it is unlikely that checks will not continue to play a significant role in the US payments system . . . . The fact that checks are still widely used suggest that checks are either an efficient means of payment or that barriers to innovation are inhibiting the development of alternatives. The Federal Reserve has emphasized the need for public and private sectors to identify any such barriers and to work to reduce or eliminate them, if so doing will serve the public interest.”

The system disclosed is an alternative to present checks, provided the Federal Reserve itself does not inhibit its adoption. Employing a new kind of check to initiate electronic payments, will not eliminate paper, but will make the use of paper in the present payment system far less costly and more efficient.

### DESCRIPTION OF THE INVENTION

It should be emphasized at this point that the invention claimed by this application is for a system or method of money payments that combines the new type of check, and other special checks described herein, with an EFT system. However, most of what follow hereafter will relate to the new kinds of checks, since the ACH and other EFT facilities are well-known public facilities. Because the primary function of the new type of check is chiefly to initiate payments via the banking system's ACH facility, the checks hereafter will be referred to hereafter as ACH, or ACH type, checks.

The Oxford Modem English dictionary defines a check as “1. a written order to a bank to pay the stated sum from the drawer's account. 2. the printed form on which such an order is written.”

The ACH check is such a written order. Like a conventional check it instructs a payor's bank to make a payment of a stated sum. Just as in the case of a conventional check, the ACH check is written on a printed check form and signed manually by the payor. Unlike a conventional check, however, it orders funds to be transferred from the payor's bank account by EFT directly to the bank account of the payee.

The check form on which an ACH check is written includes the standard Magnetic Ink Characters (MICR) at the bottom, just as on conventional checks. In addition the following items will appear on the check form in non-magnetic standard print: In the top center of the form will appear the name and address of the payor bank. The upper left hand corner will usually show the payor's name and address. Identified spaces will be provided for the amount of the payment, its date, and the number of the check. The body of the check will have identified spaces for the name of the payee; and the name of the payee's bank and its address, which can probably be limited to the name of the town and state in which the bank is located.¹ In the left hand bottom corner will appear a space where the payor's customer account and invoice numbers at the payee's place of business may be inserted, for use whenever checks are written to satisfy bills or invoices. Otherwise, as with conventional checks, that space can be left blank or used for a brief note for the payor's own mnemonic purposes. At the bottom right, just as in the case of conventional checks, is a space for the payor's hand-written signature. In most all respects the printed form, and the writing on it to complete a payable check, match those of conventional checks. The only difference in the ACH type form is the provision of spaces to show the name and address of the payee bank. A sample version of an ACH type check is set out in Appendix A to this application. ¹The town and state of the payee's should be all that is needed to find the routing number of the payee bank. This follows from the Federal Reserve policy of issuing the same routing number for all branches of a bank in any one town, except in the exceptional case of a town in which the parent bank also has a presentment center.

The very top of the printed check indicates that it is an “Automated Clearing House Check.”(See the sample in Appendix A). Alternatively, with the approval of the Federal Reserve Board, an ACH type check, drawn exclusively on the Federal Reserve System's own banks, might indicate that it is a ‘Federal Reserve System Check. (See sample in Appendix A1)

The method of payment disclosed herein provides for the check to be cancelled by the payor bank and the cancelled check, or a lawful copy thereof, to be returned to the payor once settlement is completed, along with the payor's regular monthly bank statement.

A subsidiary but important feature of the invention disclosed herein is the combination of the printed form on which the check is written with a sheet which is an exact copy of the ACH form, but on different paper, and clearly stamped or watermarked to show that it is a mere copy, and inoperative. The copy form enables a carbon or other exact and legally true copy to be made of the check as and when written by the payor. The copy is made at the same time the blank check form is filled in by type or writing by the payor, and the signature of the payor affixed. The true copy can then sent to a payee to demonstrate that indeed the “check is in the mail” and payment is on its way. Alternatively, the copy provides an opportunity for the transmission of a message or documents to the payee that the payor wishes to associate with the payment

II. The Secondary Embodiment:

The purposes of the new check described above can largely be accomplished by a simple written indorsement of a conventional check. In this embodiment of the invention a printed check form of a conventional check bears a printed notice on the reverse side. The first item of the notice is a declaration that the check is not negotiable. This is to avoid costly problems arising from negotiability that are discussed in detail hereafter. The notice continues with words to the following effect: “Please make payment by means of an automated clearing house electronic credit transaction directly to the payee's account at the (name of payee's bank), located in the city of (name of town and state in which the payee's bank is located.”) This is enough for the payor's bank to ascertain the routing number of the payee's bank and to make an ACH electronic payment accordingly. The payment order would be indorsed by the signature of the payor in a space provided for this purpose. Use of the special check by a bank would entail sending along by addenda any remittance information regarding the check, such as customer and invoice numbers. NACHA rules regulate this aspect of the transaction.

Checks containing printed material of the sort described for the secondary version of the payment system would be made available by payor banks, bound together in checkbooks with a frontispiece setting out an explanation of purpose of the printed notice and indorsement. The checkbook containing checks with the printed indorsement might, if deemed useful, also contain checks without the indorsement material for the convenience of the payor.

The use of this secondary embodiment could serve as a preliminary stage before adoption of the new check previously described. Adding this limited change in the printed forms for conventional checks might make the payment system disclosed herein more acceptable to the banking system for early adoption, as being a less radical change than the immediate adoption of the new ACH type checks. A sample of this version of the invention disclosed herein appears in Appendix B to this application.

III. A Tertiary Embodiment:

The object of the tertiary system is to avoid negotiability problems and to explicitly authorize the use of the check for truncation. The face of this special check is similar in all respects to that of conventional checks. As in the case of the secondary embodiment, the back or reverse side of the check is distinctly different: first a printed notice declares that the check is not negotiable. After that the notice goes on to state that the check is only payable at the request of the payee's bank made on the written authority of the named payee, the authority being granted by the payor's signature below the notice. The notice further provides that the check is to be paid into the payee's account at the payee bank and is payable upon electronic transmission of a copy of, or the essential data on, the indorsed check to the payor's bank by the payee bank rather than by physical transmission of the original check The whole of the instruction is indorsed by the signature of the payor following the notice. This last part of the order meets the requirement for the payor's authorization for truncation required by NACHA rules. A sample version of the back of the check used in this secondary version of the payment system disclosed herein is shown as Appendix C hereto.

### THE PRIOR ART

Description of the Prior Art:

The direct prior art consists primarily of the normal payment system involving conventional paper checks of the sort now in universal use. Today's conventional checks are negotiable instruments²that instruct banks³ to make payments from a depositor's funds to named payees. Such checks are normally prepared on a standard paper form approved by banking authorities. When one of these standard forms is filled in and signed by a payor⁴, it constitutes an order for the payor's bank to make a payment to the named payee from the payor's asset or credit account at the payor bank. Because it is a negotiable instrument, the right to receive payment of a conventional check may be transferred to a third party by simple indorsement⁵ by the payee. Because of their legal status as negotiable instruments, both the cancelled checks and any copies of them made by paying banks after settlement are subject to long-term and secure storage requirements. ²Negotiable instruments are mainly governed by state statutory law. Every state has adopted Article 3 of the Uniform Commercial Code (UCC), with some modifications, as the law governing negotiable instruments. The UCC defines a negotiable instrument as an unconditioned writing that promises or orders the payment of a fixed amount of money. Drafts and notes are the two categories of instruments. A draft is an instrument that orders a payment to be made. An example is a check. A note is an instrument that promises that a payment will be made. To be considered negotiable an instrument must meet the requirements stated in Article 3 . . . . The rule of derivative title, which is applicable in most areas of the law, does not allow a property owner to transfer rights in a piece of property greater than his own. If an instrument is negotiable this rule is suspended. A good faith purchaser, also known as a holder in due course, who does not have any knowledge of a defect in the title or claims against it, takes title to the instrument free of any defects or claims. In relation to the suspension of the rule of derivative title, Article 3 provides for warranties to protect the parties in transactions involving negotiable instruments. Checks are negotiable instruments mainly covered by Article 4 of the UCC. ³Wherever the word “bank” is used in this document it should be understood, unless the context otherwise requires, to refer to any person, natural or legal, that is capable of holding funds or credits for another person that may be paid to third persons at the instruction of their owner. Normally in discussing Automated Clearing House transactions, references to banks refer to financial depositary institutions that participate in the ACH Network. However, ACH “type” checks could be issued by private service providers that act as intermediaries to ACH banks, just as Travelers Checks are issued by private parties. The invention disclosed herein is intended to cover such privately-issued checks. ⁴The terms “payor bank” and “payee bank”, or alternatively “payor's” or “payee's” bank are used throughout this document. Many sources use “paying “bank and “presenting” bank. ⁵The term indorse, and its cognates “indorsement”, “indorsable” and the like, has recently become established both by usage in banking circles and recently by use in Federal statutes, as preferable to endorse and its associated terms. See http://www.federalreserve.gov/paymentsystems/truncation/ctact.htm.

The only other form of check now in widespread use appears to be the well-known Travelers' Check. This instrument is a specially printed document denominating a fixed sum and sold by private parties, including some banks, to consumers. Such checks constitute a promise on the part of the seller to redeem the check for its face amount when appropriately presented. When acquired, the purchaser signs the document in a designated space on the form. The document becomes redeemable when signed again by the purchaser in another space on the document. After the second signature, the check is freely negotiable and is redeemable by any holder upon indorsement and presentation to the issuing organization. Travelers' Checks serve an important commercial purpose, but they are totally unlike the new checks described herein in form and function.

There is a much more extensive part of prior art, however, which is relevant to the special function of the new type of checks disclosed herein. This special function is to initiate an electronic payment by the payor's bank, normally via the Federal Reserve's Automated Clearing House (ACH) network. ACH facilities were introduced to the banking system in the early 1970s to add a speedy and inexpensive form of electronic funds transfer to the existing wire transfer mechanism. The facilities of this network enable overnight payments⁶ to be made from payors' accounts directly to the accounts of named payees. ⁶The payment period may be extended within limits at the payor's request.

Over the past fifteen or more years many inventions and commercial innovations have been made relating to bank payments by EFT. Most of these developments relate to means for initiating EFT transactions. Some of these means are well known, e.g.: (1) Credit or debit cards; (2) Automatic Teller Machines; (3) Telephone instructions of depositors; (4) Depositor approved Internet sites of merchants; (5) Third party service providers used by depositors. Some are less well known, e.g.: (6) Prearranged debits of payors' bank accounts by merchants or service providers; (7) Debits made by billing networks, which consolidate invoices from billers and pay them on behalf of subscribers. But none provide for the use of bank checks to initiate EFT payments.(See Reference Materials below.)

Problems with the Prior Art:

The only similarity between the innovations described above and the invention disclosed in this application is that both describe ways to initiate EFT transactions. The means to do so are totally different, in that the claimed invention is the only one that provides for the use of paper checks for that purpose. Moreover, whatever the means of initiating payments disclosed in the prior art, the payment called for is usually accomplished by the payee, who, acting by advance authority of a depositor/payor, debits the depositor's bank account to receive payment for goods or services. The system disclosed herein, on the contrary, not only uses paper to initiate the process, but also orders an EFT payment to be made from the bank account of the depositor/ payor, directly to the bank account of the named payee. It is the combination of a paper check as the initiator, and the ACH or other EFT system as the executor, of non-cash money payments that is the essence of the invention claimed herein.

1. The Problem with Electronification: Something is Missing

The problems with the prior art relate partly to a missing piece in the mechanism of making electronic payments. Payments through the ACH system were initially promoted to substantial businesses organizations for recurring payments, and then for paying all their bills. This is still the most important use of EFT facilities. Later on large merchants and other service providers were allowed to debit consumer bank accounts in order to settle their bills, provided the bank received written pre-authorization from the consumer, its depositor. Later still Internet based merchants were allowed a similar privilege, except that consumers were permitted to authorize drafts on their accounts by filling in appropriate forms at the Websites of the merchants. Along the way, electronic payments by consumers were enabled by the use of credit and other cards at places of business and ATM machines

Debits to a payor's account made by prearrangement are referred in banking circles today as “direct payments,” whereas in truth nothing could be more indirect. Truly direct electronic payments by bank customers from their accounts to named payees at other banks have not heretofore been possible. There has always been something or somebody in between, —either a card, a machine, or another party. This has resulted in a rather awkward payment system in which consumers have only been able to benefit from the electronic facilities of banks by contracting with private intermediaries like Check Free and Pay Trust. The services of these organizations are undoubtedly valuable for consumers as well as small firms, but at a sacrifice of privacy, convenience and a measure of control by consumers. What is still needed is a way for bank customers to give orders directly to their banks to make payments via EFT to the bank account of designated payees. The system disclosed here does this.

According to the 2001 Federal Reserve study mentioned above, payments by paper check are still the dominant means of making non-cash retail payments in this country, accounting for some 60% of all such payments. The fact that paper checks are the dominant mode of payment, despite all the apparent advantages of electronic means, indicates pretty clearly that something is still missing in the electronic payment system, and it also suggests a remedy. The new system disclosed here yields the missing link in the electronic system by providing for a new kind of bank check that can directly initiate payments to be made through the EFT systems of banks, notably the ACH facility.

2. The Problem with Paper Checks: They are Too Costly.

In the present system checks cannot do the job. Conventional checks cannot be used to initiate EFT payments because they are by long tradition negotiable instruments which are sent directly to named payees for eventual presentment and payment by the payor's bank. (But see the secondary embodiment of the invention below)

Moreover, the expenses associated with the use of conventional paper checks are enormous, currently estimated, as noted above, at more than $125 billion per year. Despite the adoption by NACHA of special expedients to eliminate costs from the system, checks written today follow almost the same elaborate route of handling and physical transport between their writing and their payment as before. Conventional checks, —the ordinary, everyday checks in universal use, —are negotiable instruments intended to be delivered to payees, then delivered by the payees to payee banks, then sent by payee banks to clearing-houses, and thence, after settlement of net debt and credits of the banks in the clearing houses, sorted and assembled for transport in bulk to the respective payor banks for cancellation and storage, or else returned, in original form or copies, to payors. This is the elaborate “journey” of paper checks through the payment system that is referred to herein as the “paper route.”

In some cases clearing houses are not used: An obvious instance is known as an “on-us” transaction, where payment is to made to another depositor at the payor's own bank. This, of course, avoids the paper route entirely. Another is where settlement is made directly by the payee with the payor bank, avoiding all but the initial stage of the route, and yet another where settlement is made through another federal reserve bank acting itself as clearing agent. Whatever the particular routing, the conventional checks go through the hands of a number of persons and require several incidents of mailing and other physical transport as they wend their way back to the payor bank for settlement.

The extensive handling of checks along the route is not only expensive, but is fraught with risks of errors, physical damage, and other inadvertent losses. Errors arise even in the machine reading of the MICR (magnetic ink characters), digits required by the Fed to be printed at the bottom of every check. To these costs must be added the risk of fraud. Because conventional checks are negotiable instruments, and expressly designed to be indorsable for transfer of payment rights to others, check forms can be stolen and bogus checks written on them. Properly issued checks can also be lost or stolen along the paper route, resulting in fraudulent indorsement. A large fraction of checks are written at points of purchase, and the frequent incidents of fraud at those points result in heavy costs to merchants. Although the occurrence of fraud at points of purchase and other points along the paper route is minor in proportion to the total number of checks written, the expense in absolute numbers is very, very large.

Added to the above costs are the expenses of sorting and assembling checks and bulk transport of checks among banks after settlement of clearing accounts. The ultimate storage of cancelled checks at the end of their journey adds a further heavy expense. Because conventional paper checks are negotiable instruments, the law requires the original checks to be stored securely for three months and copies to be archived thereafter for seven years. Furthermore, the manner of storage must ensure that the checks, and their copies, can be retrieved at any time on the request of an authorized party. This is a costly business. Finally, there must be added the expense of reversal of payments arising from non-payment of checks for fraudulent issue or insufficient funds. Some 350 million checks were returned in the year 2000. This last expense is amplified whenever legal enforcement is required to collect from a delinquent or miscreant check writer.

The National Automated Clearing House Association (NACHA), which regulates the ACH Network, has adopted some special expedients to mitigate the cost burden of paper checks. NACHA rules now allow banks to “truncate” (i.e. eliminate) a part of the paper route. That is, payee banks, having received checks from depositors, are permitted, under strict conditions, to transmit electronic copies of checks, or the essential data from checks, to the next stage of the route back to payor banks, retaining the physical checks themselves for legal storage. This process eliminates an important stage in the paper route, but at the cost of two way electronic communication between the payee and payor banks in its place. Though presumably less costly, this also is not without cost.

NACHA rules also permit merchants to short-cut the routing process by capturing data from and then voiding checks tendered to them at points of purchase (POP). The merchants then transmit the captured data electronically to payors' banks to effectuate payment via the ACH network. The cancelled checks are returned to the payors by the merchants and thus avoid the costly physical routing procedure altogether. This is very helpful in reducing costs since it is estimated that 20-30% of all checks are presented at points of purchase. The Point of Purchase (POP) privilege happens to show clearly that neither negotiability nor retention of checks by banks are essential to the money payments process.

Regrettably, truncation and the POP short-cut are not as widely used as they might be. Truncation is complicated by requirement that payors specially authorize it. Moreover, legal experts have raised a number of objections to truncation in the present status of the law, having to do mainly with the legal status of the substitute electronic checks. At all events, as of today, the expedients of truncation and the point of purchase shortcut have only made a small dent in the overall costs of the use of paper checks. The matter of truncation is now under active study by the U.S. Congress, which is considering legislation proposed by the Federal Reserve to authorize and regulate the truncation process.

Whatever the outcome, it seems clear that many of the costs of the paper route will continue, unless some other innovative and acceptable means is devised to curb them. It is believed that the novel system disclosed herein can do just that: the combination of the new kind of check disclosed herein, together with the known means for electronic transmission of funds between banks, eliminates far more of the costs of the paper route than the expedients devised by NACHA.

### OBJECT AND ADVANTAGES OF THE NEW SYSTEM

This section describes the objects and advantages of the main embodiment of the system, at length. It then discusses more briefly how the same or slightly different objects and advantages follow from the use of the secondary and tertiary embodiments of the system.

A. The Object and Advantages of the Main Embodiment

The object of the main version of the invention is twofold: first, it is to add bank checks to the means of initiating EFT payment transactions; second, it is to introduce a new kind of check, for use in combination with EFT facilities as a new, less costly method of making non-cash retail payments.

1. Using the new checks to initiate ACH transactions: Heretofore the means of initiating ACH and other EFT transactions have excluded checks, probably because the traditional checks have always been sent to payees. Other instructions for payments, whether initiated by credit or debit cards, or by ATM or telephone instructions, or by direct electronic transmissions, are all sent directly to the payor bank, not to payees.

The new system set forth herein accepts the established fact that a great many persons, especially individual consumers, for one reason or another, prefer paper checks over other means for making non-cash payments.⁷ Why not take advantage of this preference and allow paper checks to be used to initiate electronic payments, through the ACH or other EFT facility of the banking system? The present absence of that possibility is a glaring omission from the panoply of means to bring the ACH facility into more widespread use. By thus encouraging the use of the ACH network, the new system thus serves public policy, for it is a declared policy of the Federal Reserve to enlarge the use of ACH facilities. ⁷See the Greenspan speech referred to in the Reference Materials below.

The use of the new checks in conjunction with ACH facilities will also serve a more general purpose, namely, as an additional means of making non-cash retail payments, right alongside credit cards, ATM machines and conventional checks. The new check system caters to the public: it is designed to “go with the flow” and accept the public love affair with paper checks. To do so, however, the new checks have to please consumers and small businesses, as well as banks. For that reason the new ACH checks are designed to be very similar to conventional checks in form and appearance. ACH checks⁸ have all the functional advantages of ordinary checks, as well: they are just as private; they are processed solely by banks, which are regarded as more trustworthy than intermediary private firms; they enable payments to be made anywhere, any time, without the need of access to special equipment, just like ordinary checks; and the payor has access to cancelled checks, or legal copies thereof, for records and proof of payments. ⁸If the Federal Reserve System were to allow the ACH type checks to be called “Federal Reserve System” checks, the public would be even more inclined to use them.

2. Using the new checks to reduce costs: The new system will eliminate most of the costs and risks associated with conventional checks. Costs of mailing, handling, and processing conventional checks are necessary concomitants of the paper route and are its major costs. These costs are not present at all in the case of ACH type checks, since the new checks never leave the payor's bank, except to be returned to the payor. The paper route is entirely avoided.

Other costs and risks: These mainly arise out of two features of the present system: the fact that conventional checks are negotiable, and the fact that they are intended for delivery to payees. Another significant cost arises from overdrafts.

As for negotiability: In times past the legal negotiability of checks served a useful purpose: when the population was less dense, banks fewer, and alternative means of payment largely unavailable, the capacity of checks to serve, by indorsement, as a kind of substitute and safer legal tender than cash was very useful. Indorsement could be restricted to a single transferee, or, if unrestricted or made to “bearer.” When drawn on a good bank, a check could be used almost like cash and transferred from hand to hand before finally being cashed at the bank. In a more rural society the ‘holder in due course’ protection afforded by negotiable instruments law was very practical. It prevented a check from being dishonored when presented to a bank by an innocent indorsee, despite defenses a prior holder might have been able to assert. But the environment has changed radically since then. There are banks everywhere and means of payment have multiplied with the incursion of travelers' checks, credit cards, debit cards, charge cards, ATM machines, and a variety of electronic means of payment.

The problem of fraud: Negotiability today is at most a minor convenience for payees. It serves more as a cover for fraud than as a useful privilege for payees. Negotiability first of all opens the door to the risk of bogus checks. Check forms can be pilfered from bank depositors, and used by miscreants to write checks over the forged signature of the payor. Then there is the problem of fraudulent indorsement. Legitimate checks can be lost or stolen and then fraudulently indorsed for payment at the payee's bank or further transferred to another party, who as an innocent holder in due course of a negotiable instrument cannot be denied payment on account of the prior fraud. Although fraud of any kind is very infrequent compared with the number of conventional checks written, less than one percent its cost in absolute numbers is in the billions of dollars every year, much of which falls on merchants and banks.

On the other hand, the risk of fraud in the case of ACH checks is inconsequential. Fraudulent issue is highly unlikely since ACH checks are written and presented to a payor's own bank, usually in person, where the payor is known. No loss can occur except from outright forgery; and the risk of forgery is negligible since an ACH check is only payable to a named party at a designated bank. Thus, a forger would have to provide for payment into an account in his own name at an identified bank, making his eventual detection almost inevitable.

As for loss or theft and the risk of ensuing fraudulent indorsement, no material loss occurs because the instruction on the check to make a payment directly to the account of a particular person at a particular bank is not alterable by indorsement.

The problem of storage: Negotiable instruments law requires the secure storage of cancelled checks as well as their digital copies, for a lengthy period, as noted before. And the storage must permit prompt retrieval of individual checks or copies at the request of authorized parties to a check transaction. This costly requirement is totally avoided by the proposed new check system

Quite aside from these risks, the advance of technology and the increase of alternative means of payment have outrun any need of negotiability for checks. Indeed, most business payments today do not require paper checks at all. They are now generally accomplished wholly by electronic means. Instructions for electronic payments go directly to the payor's bank and there is no counterpart to the paper route for them. Similarly, ATM payments are converted directly into electronic instructions, as are credit card charges. There is no reason there should not be a paper equivalent, and ACH checks are designed to be just that, the consumer equivalent of electronic payment instructions. (See excerpts from references in the list of “Other Relevant Material” on page 3.)

As for delivery to payees: As noted above the elaborate journey of paper checks between payor and payee and back is obviated entirely in the case of ACH type checks. An ACH check has only to be mailed, or delivered in person, to the payor's bank, which is usually a local matter. That is all. No longer must a check to be sent to a payee, then delivered by the payee to the payee's bank, then routed through clearing houses to the payor's bank for eventual settlement. The normal paper route not only requires time and delayed payments, it is also leads to enormous expense for the banking system when multiplied by billions of check transactions. The truncation expedient adopted by NACHA and indorsed by the Fed in the legislation now under consideration is useful for ordinary checks, but unnecessary for ACH checks. (See discussion in later paragraphs)

As for overdrafts: Another major cost of conventional checks is the occasional necessity to dishonor checks for errors or insufficient funds. Unfortunately people do sometimes get careless and write “overdrafts,” that is, checks drawn without funds in the bank to cover them. Occasional miscreants do this deliberately. ACH checks cannot prevent this. However, ACH checks avoid almost all of the expenses that ensue from dishonored checks. The major expense results because conventional checks are delivered to payees and are sent on to payee banks before a payor bank knows anything about the matter. Once an error is discovered, reversal of the transaction necessitates an elaborate trip back to the payor bank, which must then settle the matter with the payor, sometime requiring enforcement by resort to the judiciary process. This cannot happen with an ACH check. In its case any error or insufficiency of funds is bound to be discovered at the outset, when the ACH check is received by the payor bank, and before any other party has become involved.

3. Other Advantages of the New Checks:

In addition to the avoidance of the expenses inherent in the use of conventional checks, ACH checks can take advantage of some of the new cost-avoidance procedures initiated by NACHA, in particular the initiation of an ACH electronic payment at the point of purchase (POP) of goods or services. Over 10 billion checks are written each year at points of purchase. The incidence of fraud or error in such checks leads to heavy losses for merchants. The POP privilege described earlier helps avoid these problems. ACH type checks serve the POP privilege as aptly as conventional checks.

But ACH checks do more. With ACH checks there is no reason why the POP type procedure cannot be used with distant merchants. As an example, an ACH check could be sent to a mail order house for purchase of items. Just as in the case of POP transactions, the data from the check could be captured by the mail order merchant, sent electronically to the payor's bank for payment and the check voided and returned by mail to the payor. This is not acceptable with conventional checks because of the risks of loss in the process and ensuing fraudulent indorsement. This risk does not arise with ACH checks because, even if an ACH check is lost in the mail, the only loss is one of convenience. Moreover, while smaller retail merchants frequently cannot afford the electronic equipment required by the point of purchase privilege, mail order houses are large enough to have ample means to acquire such equipment. The extension of the POP type privilege should thus find much more extensive use.

As for the truncation procedure authorized by NACHA: In its search for methods to save costs of the risky and expensive paper route of conventional checks, NACHA devised the truncation procedure. Truncation at the payee bank serves a laudable purpose and does indeed curtail the roundabout journey for conventional checks. But use of the new type checks is far simpler and less costly than truncation. For, in a sense, new checks ‘truncate’ that journey before it starts, by virtue of the fact that the check is no sooner written than it is sent immediately to the payor bank for payment.

The use of the new checks fits comfortably into the ACH system. NACHA rules expressly allow Customer Initiated Entries (CIEs). These are defined as debits or credits posted to the accounts of customers at ACH participating banks. Although NACHA rules relating to CIEs at this time largely concern transactions initiated by service providers acting on behalf of payors, the rules expressly recognize CIE transactions initiated by individual payors acting for themselves. The use of ACH checks will effectively substantiate that promise of the NACHA rules.

4. Advantages to Consumers: Widespread use of ACH type checks would not only eradicate a large part of the cost of conventional checks from the banking system, but also, if banks have the wit and grace, to consumers too. For, in consideration of their lesser costs, there is no reason why the fees charged by banks could not be reduced, or even eliminated altogether for transactions based on the ACH checks.

5. Advantage to Payment Organizations: Quite aside from the above, if the Federal Reserve and the NACHA banks do not accept the new checks, there is no reason why private service providers, even individual banks, should not undertake to do so, —that is, to put in use a “check” that would be a counterpart of the ACH type check. Service providers that now assist consumers in paying bills, or even smaller banks, might reach a broader clientele by offering ACH type checks to consumers.

One of the features of paper checks that consumers have traditionally prized is the receipt of cancelled checks as proof of payments. While the privilege of receiving the cancelled checks themselves has been eliminated by public policy, microfiche or digitized copies have been legalized for such proof. There is no reason that private intermediaries cannot provide not only the comforts of written checks, but receipt of the original cancelled checks. This possibility is covered by the claims made herein, but it will be unfortunate if the privilege of a new and advantageous payment instrument is not made available to the public at large by the banking system itself so this is unnecessary.

6. Advantage to Public Policy: A point should be made regarding general policy. The introduction to NACHA rules explicitly state that a basic policy is to “promote the growth in ACH volume.” At the same time policy makers (see Rivlin comment in the Introduction) recognize that paper checks will continue in widespread use for a long time. The new ACH type check can be an effective way-station to the eventual complete transition to an electronic payment system, for consumers as well as small business firms. The paperwork involved in transactionsbased on ACH checks starts and ends with bank customers sending checks to their banks. At that point the EFT part of the transaction takes over. All the other paperwork associated with conventional checks is avoided by use of ACH checks.

B. The Object and Advantages of the Secondary Embodiment:

The chief object of the secondary embodiment is to initiate EFT transactions by means of a conventional check rather than the new check described in the main embodiment. However, the conventional check in this case is special in that it is provided with a printed indorsement form on it back or reverse side. The printed form is an instruction to the payor's bank, over the signature of the payor, to make a payment directly to the payee's bank account at the designated bank of the payee, by means of an ACH credit to the payee bank.

This embodiment does almost everything an ACH type check will do, but without the appearance of a radical change from checks that have been in universal use for such a long time. This version of the system of a combined check and EFT transaction could thus serve as a preliminary step in the conversion to the new payment system described herein, one that may be easier for the banking industry and consumers to accept and put into effect than the more radical change set forth in the main embodiment. The change to new ACH type checks could follow later.

This secondary version could also be given practical effect by printing multiple copies of the specially endorsed checks for distribution to the public in checkbooks, or other forms, such as printing software, together with explanations of the purpose of the special indorsements. The savings in costs by avoiding the paper route entirely should enable banks to charge much less, if anything at all, for the use of these special checks.

C. The Object and Advantages of the Tertiary Embodiment:

The object of the tertiary version of the new system is different than the other versions, for it is designed to assist with the truncation process, which is almost surely going to be established in law. Indeed this version of the basic invention set out in this application may be made inapplicable by the truncation law. But if not, it could assist in winning over consumers to the advantages of truncation.

In essence it, like the secondary embodiment, is a variant of the basic system for using a paper check to initiate electronic payments. The process just takes place later in the paper route than is the case with the other embodiments.

As with the secondary embodiment above, the special feature of this embodiment consists of printed notice and form of indorsement on the reverse side of an otherwise normal conventional check. The object of this special notice is not only to avoid negotiability problems, but also to give explicit authorization for truncation. The principal advantage is the avoidance of the risks and costs arising out of negotiability, as described in detail in the previous section. Secondly, by explicitly authorizing truncation, indorsement of the check provides automatic approval of truncation by the payor, as required by NACHA rules. Truncation, of course, curtails the paper route, resulting in substantial savings to participating banks

To recapitulate the advantages of the new system: It

1. Simplifies the check payment process for consumers.

2. Enables those who prefer to use checks to benefit from electronic payments.

3. Serves public policy by encouraging greater use of ACH network.

4. Radically speeds completion of check based payments.

5. Effects large savings in costs of mailing, handling and processing checks.

6. Avoids problems of loss, theft and fraud associated with negotiability.

7. Avoids errors from repeated handling, mailing, MICR reading, etc.

8. Reduces expenses of overdrafts and erroneous or fraudulent checks.

9. Extends POP privilege to mail order and other distant merchants.

10. Preserves consumer right to cancelled checks, or copies, for proof of payments.

11. Allows use of new type checks by private service providers.

12. Eases transition to eventual all-electronic money payment system

13. Assists the truncation procedure, in the third embodiment

D. Possible Disadvantages of the New System:

1. Absence of Float:

Many commentaries on the predilection of consumers for paper checks refer to the advantage of “float,” meaning the availability to consumers of a few days grace between writing a check and having their bank accounts debited. While the reality of this so-called advantage is challenged by others, there is no doubt that bankers encounter this view among their customers. The absence of a similar grace period in the new system is criticized as a disadvantage. Yet there is at least a partial answer to this objection. The new system provides for copies of each check to be made at the time the check is written. It is a simple matter for the consumer/payor to send the dated copy of the check to the payee to show that the payment is in process. The time between the mailing of the copy and the expectation of the payee for receiving funds, a matter of at least a few days at least, can then be allowed to expire before the payor delivers the actual check for overnight payment under the new system. This is the equivalent of float in any practical sense, and is no more dubious a practice than the present one.

2. Difficulty at Certain Points of Purchase:

Another criticism has been made that neither the new ACH type check, nor the conventional check with the special indorsement, can be used to make a quick payment at some points of purchase as, for example, in a payment line at a food mart, where no electronic equipment is available to send the data from the check to the payor's bank. A conventional check, on the other hand, —so goes the criticism, —can easily be written and simply handed over to the cashier.

There is some truth to this objection, but it is limited. For in truth the new check can be used in such a situation: it can be written to the merchant as payee, as with a normal check. At the same time the payor can write on the back to show explicitly that it is to be sent to the payor's bank for payment. The bank's address is printed on the face of the check, so it is simple for the merchant to put the check in the mail. Until the new type of check is familiar, however, this might cause some problems, since most merchants are accustomed to sending checks presented by customers to their own banks. But, at worst, the merchant/payee would send the check to its own bank, in which case the check would merely be processed along with the conventional checks in the normal fashion. Since this would deprive the merchant of several days of interest on the amount of the check, however, the merchant has a strong incentive to become familiar with the new system as more of the new type checks are presented.

3. It has been suggested that the new system would deprive banks of the significant revenues earned from penalties assessed on customers for overdrafts. But this is not so. The new checks could also be written against insufficient funds and would be subject to the same penalties. Furthermore, because the new checks require the name and town of the payee's bank to be entered on them, a mistake in this information would also be subject to penalty. If so, banks would have a new source of revenue not available from conventional checks.

[image]

[image]

[image]

Reference Materials

Listed below are patents relating to particular inventions relating to innovations of the kinds indicated in the list at the end section above entitled “Description of the Prior Art. Below the list of patents is another list of sources of information pertaining generally to EFT transactions and paper checks.

Patents re initiation of electronic payments:

Basic Electronic:

U.S. Pat. No. 6,032,133

U.S. Pat. No. 5,677,955

Payment Networks:

U.S. Pat. No. 6,408,284

U.S. Pat. No. 6,128,603

U.S. Pat. No. 6,032,133

U.S. Pat. No. 5,920,847

U.S. Pat. No. 5,699,528

Pre-authorized debits:

U.S. Pat. No. 5,504,677

U.S. Pat. No. 5,496,991

Service Providers:

U.S. Pat. No. 6,173,272

Internet Payments:

U.S. Pat. No. 6,246,996

Other Relevant Materials:

Electronic Funds Transfer Act (15 U.S.C. 1693 et seq.)

Federal Reserve System's Regulation E (12 CFR 205)

Rules of the National Clearing House Association. (nacha.org)

Article 4, Universal Commerce Code

On Persistence of Checks:

See Rivlin. “Role of the Federal Reserve in the Payment System” before the Subcommittee on Domestic and International Monetary Policy of the Committee on Banking and Financial Services, U.S. House of Representatives Sep. 16, 1997. But see the more recent study of Federal Reserve at www.federalreserve.gov/pubs/bulletin/2002/0802 2nd.pdf

On Negotiable Instruments:

The Irrelevance of Negotiable Instruments Concepts in the Law of Check-Based Payment Systems, 65 Tex.L. Rev. 929 (1987). Excerpt:

“It is often wrongly assumed that the modem check collection system requires the following three effects of applying negotiable instruments law: standardization of the rights and obligations of the parties to a check; the reification of the payment obligation in a piece of paper; and the ability of certain transferees to take the check free from certain claims or defenses that other parties to the check might raise. While negotiability helps explain a payment system based on bank notes, it does not help explain a payment system based on instructions to withdraw finds from deposit accounts.”Negotiability—Who Needs It? 71 Colum. L. Rev 375 (1971). Excerpt: “Holder in due course allocates losses between two innocents; the problem arises because the wrongdoer cannot be made to bear the losses he or she caused. Given that splitting the difference has not historically been an option, the apparent inequity of the result is justified by reference to the need to protect the buyer's reasonable expectations in order to promote the growth of markets and commerce. Law professors emphasize the remarkable nature of HDC to spark the interest of law students in what would otherwise be a dull course; HDC doctrines can be especially unfair when applied to consumers. Negotiability doctrines fail to take account of the realities of the modern check collection system.”

On Federal Reserve study of costs of processing paper checks see: www.minneapolisfed.org/research/qr/qr2041.pdf

On truncation: For draft statute and analysis proposed by the Federal Reserve Board, see: http:/www. federalreserve.gov/paymentsystems/truncation/ctact.htm

On consumer preference for checks: see Greenspan speech at http://www.federalreserve.gov/boarddocs/speeches/2000/20000410.htm

On check errors see: http://www.frbsf.org/fiservices/letters/checks/2000/000327.sea.html

Other Websites:

Electronic Payments Primer. (stls.frb.org)

Epayments (ny.frb.org/bankinfo/ebanking/epay.html)

Bibliography of ACH.(robotics.stanford.edu)

Electronic checks, graphical. (epaymentsystem.com)

Direct epayment Standard: ecommercetimes.com/perl/story/11930.html

Federal Reserve Bank of NY:www.ny.frb.org/bankinfo/ebanking/epay.html

Primer on ebanking: www.stls.frb.org

Check studies: (:www.greensheet.com/checkstudy.html

nacha.org/news/news/pressreleases/PR071499/pr071499.htm

pubs.nacha.org/echeck.html

cybersource.com

paybycheck.com

telecheck.com

echeck.com

1. What I claim as my invention is a system or method whereby customers of organizations holding funds, assets or credits on behalf of other parties (hereafter referred to as “banks”), are enabled to make money payments to the accounts of named payees at the same or other banks by means of electronic transfers of funds in combination with new kinds of paper instruments, said instruments being non-negotiable and designed to be sent to the customers' banks for payment of funds by electronic means directly to the bank accounts of said named payees at designated banks.

2. What I further claim as my invention is a system or method whereby customers of organizations holding funds, assets or credits on behalf of other parties (hereafter referred to as “banks”) are enabled to make money payments to named payees of the same or other banks by means of electronic transfer of funds from accounts of said customers at said banks to the accounts of named payees at designated banks, pursuant to orders given by said customers to their banks on new kinds of bank checks or other paper instruments, said checks or instruments to be in written form (which now and hereafter in these claims means wholly hand-written or partly hand-written and partly typed or printed), and delivered by customers of said banks to their own banks for payment, said checks or other instruments being identified by any appropriate means thereon as being non-negotiable and payment rights conveyed by them to be non-transferable to other parties by indorsement or otherwise, and the printed forms of said checks or other paper instruments to set forth at indicated places thereon the following items of information: a) the Magnetic Ink Character Readable (MICR) digits required by federal regulation for bank checks in general use today; b) the date the check is made; c) the number of the check; c) the amount to be paid; d) the name and address of the customer of the bank that will make the make the payment so ordered (the payor hereafter); e) the name of the payee; f) the name and address of the payee's bank, and, if required by law or regulation, its routing number, or, alternatively, the name of the bank and the town and state wherein it is located; g) the hand-written signature of the payor; and h) optionally, a space for a customer account number designated by the payee and/or the number of the invoice or bill of the payee to be paid by the check or other paper instrument in question as and when appropriate for the payment of bills or invoices, and otherwise for special notes of the payor.

3. What is further claimed as my invention are means for making true copies of the paper forms on which said aforementioned checks or other paper instruments are to be written, including copies of the typed or handwritten additions made by the payor on said forms; and further a combination of said copies with messages and/or documentary material to be sent to the named payees of said checks or other paper instruments, said combination being suitable for transmission by mail or other means to the named payees of said checks or other paper instruments.

4. What is further claimed as my invention is a system for money payments by means of special checks in the form of conventional checks now in everyday use combined with electronic funds transfers facilities, each of said checks to bear on its back or reverse side a common printed notice to the following effect: that the check is not negotiable; that payment of the amount indicated on the check is to be made by electronic transfer of funds from the payor's account at the payor's bank to the payee's account at a designated bank at a designated address; the whole of said printed, written and typed matter to be followed by the payor's signature indorsing the preceding material.(See Appendix B for a sample version of such an indorsement); and what is further claimed as a subpart of this claim is the form of a conventional check with such a printed notice on the reverse side in combination with a checkbook containing multiples of such checks with or without a page in the front of the book explaining the purpose and effect of the printed material.

5. What is further claimed as my invention is a method for making money payments via electronic transfer of funds pursuant to an order to a bank by means of a check in the same form as conventional checks now in everyday use, except that the back or reverse side of the check bears a printed notice stating that: (a) the check is not negotiable;(b) is payable only pursuant to the order of the bank designated by the payee in writing in a space provided for that purpose; (c) is payable only to the bank account of the payee at such designated bank; and (d) is payable by electronic finds transfer from the payor's bank account at the payor's bank directly to the bank account of the payee at the designated bank through the facilities of the Automated Clearing House facility of the Federal Reserve, or by such other electronic means agreed by the payor and payee banks; and (e) is payable in accordance with the truncation procedures of the National Clearing House Association, or other applicable law, by presentment to the payor's bank of an electronic copy of the payor's check indorsed by the payee, or by electronic transmission of all necessary or appropriate data contained on the payor's check, as agreed for this purpose by the banks of the payor and the payee; all as confirmed by insertion of the name of the payee bank in a space designated for that purpose and by the payee's indorsement of the matter in subsections (a) through (e) above by the payee's handwritten signature following the printed notice.

6. What is further claimed as my invention is a system or method for initiating electronic money payments from a bank through the intermediary agency of a private organization, said organization acting on the legal authority and instruction of a customer of said bank given to the intermediary organization by means of special printed check on which the payor's written order for payment is given, said check or other written instrument to be in the form and having the characteristics of the checks or other instruments described in any of the claims 1 through 4 above, and delivered by the payor to the intermediary organization for payment by said bank pursuant to existing contractual arrangements of the intermediary organization with said bank.
